(19) United States
(12) Patent Application Publication
(10) Pub. No.: US 2026/0037262 A1
(43) Pub. Date: Feb. 5, 2026

(54) SINGLE INSTRUCTION REGISTER PROVIDING MULTIPLE INSTRUCTION OPERANDS

(71) Applicant: INTERNATIONAL BUSINESS MACHINES CORPORATION, Armonk, NY (US)

(72) Inventor: Peter Jeremy RELSON, Ulster Park, NY (US)

(21) Appl. No.: 18/790,951

(22) Filed: Jul. 31, 2024

(51) Int. Cl. G06F 9/30

(52) U.S. Cl. CPC G06F 9/30109; G06F 9/30036; G06F 9/30101; G06F 9/34; G06F 9/355

(57) ABSTRACT

An instruction is executed within a computing environment. Executing the instruction includes obtaining a plurality of operands of the instruction. Obtaining the plurality of operands includes retrieving from a register of the instruction multiple designations of multiple operand locations. The multiple operand locations are used to provide multiple operands of the plurality of operands of the instruction. Multiple operands of the instruction are determined from the multiple operand locations. One or more operations of the instruction are performed using one or more operands of the plurality of operands of the instruction to obtain a result of the instruction.

### BACKGROUND

One or more aspects relate, in general, to facilitating processing within a computing environment, and in particular, to improving instruction processing within the computing environment.

Instructions to be executed within a computing environment are part of an instruction set architecture that defines the instructions, including formats of the instructions. There may be a number of different formats for the instructions, but typically, each instruction format has one or more constraints associated therewith. For example, an instruction format may be of a defined size, and therefore, is constrained in the number of operands that the instruction may use. The operands include the data (e.g., values, expressions, other information) used to perform an operation of the instruction.

### SUMMARY

Shortcomings of the prior art are overcome, and additional advantages are provided through the provision of a computer program product. The computer program product includes a set of one or more computer-readable storage media and program instructions, collectively stored in the set of one or more computer-readable storage media, for causing at least one computing device to perform computer operations. The computer operations include executing an instruction within a computing environment. Executing the instruction includes obtaining a plurality of operands of the instruction. Obtaining the plurality of operands includes retrieving from a register of the instruction multiple designations of multiple operand locations. The multiple operand locations are used to provide multiple operands of the plurality of operands of the instruction. Multiple operands of the instruction are determined from the multiple operand locations. One or more operations of the instruction are performed using one or more operands of the plurality of operands of the instruction to obtain a result of the instruction.

In one or more aspects, a computer program product is provided that includes a set of one or more computer-readable storage media, and program instructions, collectively stored in the set of one or more computer-readable storage media, for causing at least one computing device to perform computer operations including executing an instruction within a computing environment. Executing the instruction includes retrieving from a register of the instruction at least one base-displacement pair of multiple base-displacement pairs located within the register. The at least one base-displacement pair is to be used to provide at least one operand of the instruction. The at least one operand of the instruction is determined from the at least one base-displacement pair. One or more operations of the instruction are performed using, at least, the at least one operand of the instruction to obtain a result of the instruction.

In one or more aspects, a computer program product is provided that includes a set of one or more computer-readable storage media, and program instructions, collectively stored in the set of one or more computer-readable storage media, for causing at least one computing device to perform computer operations including executing an instruction within a computing environment. Executing the instruction includes retrieving from a register of the instruction at least one operand location designation of a plurality of operand location designations located within the register. The at least one operand location designation is to be used to provide at least one operand of the instruction. The at least one operand of the instruction is determined from the at least one operand location designation. One or more operations of the instruction are performed using, at least, the at least one operand of the instruction to obtain a result of the instruction.

Computer program products, computer systems and computer-implemented methods relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present disclosure;

FIG. 2 depicts one example of further details of a processor of the processor set of FIG. 1, in accordance with one or more aspects of the present disclosure;

FIG. 3A depicts one example of a format of an instruction, in accordance with one or more aspects of the present disclosure;

FIG. 3B depicts one example of instruction text of the instruction format of FIG. 3A, in accordance with one or more aspects of the present disclosure;

FIG. 3C depicts another example of instruction text of the instruction format of FIG. 3A, in accordance with one or more aspects of the present disclosure;

FIGS. 4A-4C depict examples of expanded content registers used in accordance with one or more aspects of the present disclosure;

FIG. 5 depicts one example of the instruction execution using expanded register contents code of FIG. 1, in accordance with one or more aspects of the present disclosure;

FIG. 6 depicts one example of an instruction execution process, in accordance with one or more aspects of the present disclosure; and

FIGS. 7A-7B depict another example of a computing environment to incorporate and use one or more aspects of the present disclosure.

### DETAILED DESCRIPTION

In accordance with one or more aspects of the present disclosure, a capability is provided to facilitate processing within a computing environment. In one or more aspects, the capability includes enabling instructions that are architecturally or environmentally constrained in the number of operands that they can use to be able to use additional operands. In one or more aspects, the additional operands are supplied by expanded register contents in which a register of the instruction is configured to store multiple designations of multiple operand locations used to provide multiple operands. An operand location in a register is, for instance, another register that includes an operand or information to determine an operand; an information set that includes values when combined provide an operand or information to determine an operand, such as a base-displacement pair that includes a base register having a value and a displacement value, which when concatenated, provide an operand or information to determine an operand (and/or other information sets); a field within the register that includes the operand or information to determine the operand, etc. Information to determine the operand includes, but is not limited to, information that generates, locates or defines the operand, as examples. Other examples of information to determine the operand and/or operand location are possible.

In one example, based on an operand location of the multiple operand locations an operand of the instruction is determined. Thus, multiple operands of the instruction are determined from the multiple operand locations of a single register.

The use of the register with expanded register contents provides instructions with the ability to perform additional and/or more complex operations or functions without configuring new instructions, saving on storage and processing resources. Further, instructions may be architected that use more operands than were previously available, enabling the configuring and use of instructions that previously were undefined due to constraints of, for instance, the architecture and/or environment.

In one or more aspects, a computer program product is provided. The computer program product includes a set of one or more computer-readable storage media, and program instructions, collectively stored in the set of one or more computer-readable storage media, for causing at least one computing device to perform computer operations. The computer operations include executing an instruction within a computing environment. Executing the instruction includes obtaining a plurality of operands of the instruction. Obtaining the plurality of operands includes retrieving from a register of the instruction multiple designations of multiple operand locations. The multiple operand locations are used to provide multiple operands of the plurality of operands of the instruction. Multiple operands of the instruction are determined from the multiple operand locations. One or more operations of the instruction are performed using one or more operands of the plurality of operands of the instruction to obtain a result of the instruction. Use of a single register to provide multiple designations of multiple operand locations to obtain multiple operands improves instruction processing by enabling more operands than the instruction text can support to be used by the instruction. Processing cycles are saved and performance is improved by enabling use of more operands by one instruction, thus, providing more functionality with one instruction. Use of multiple designations provides other operands when a parameter block or similar structure is unavailable or, if available, may replace use of a parameter block for operands, which reduces memory accesses that would have been needed to obtain the additional operand information.

Additionally, or alternatively, in one example, the multiple designations of the multiple operand locations include multiple information sets. An information set of the multiple information sets includes a set of values that are combined and used to provide an operand of the multiple operands. Use of a single register to provide multiple information sets improves instruction processing by enabling more operands than the instruction text can support to be used by the instruction. Processing cycles are saved and performance is improved by enabling use of more operands by one instruction, thus, providing more functionality with one instruction. Use of multiple designations provides other operands when a parameter block or similar structure is unavailable or, if available, may replace use of a parameter block for operands, which reduces memory accesses that would have been needed to obtain the additional operand information.

Additionally, or alternatively, in one example, the multiple information sets include multiple base-displacement pairs. The multiple base-displacement pairs are used to determine multiple operands of the instruction, and the multiple base-displacement pairs are included in the register of the instruction. Use of a single register to provide multiple base-displacement pairs improves instruction processing by enabling more operands than the instruction text can support to be used by the instruction. Processing cycles are saved and performance is improved by enabling use of more operands by one instruction, thus, providing more functionality with one instruction. Use of multiple designations provides other operands when a parameter block or similar structure is unavailable or, if available, may replace use of a parameter block for operands, which reduces memory accesses that would have been needed to obtain the additional operand information.

Additionally, or alternatively, in one example, the multiple designations of the multiple operand locations include multiple base-displacement pairs. The multiple base-displacement pairs are used to determine multiple operands of the instruction, and the multiple base-displacement pairs are included in the register of the instruction. Use of a single register to provide multiple base-displacement pairs improves instruction processing by enabling more operands than the instruction text can support to be used by the instruction. Processing cycles are saved and performance is improved by enabling use of more operands by one instruction, thus, providing more functionality with one instruction. Use of multiple designations provides other operands when a parameter block or similar structure is unavailable or, if available, may replace use of a parameter block for operands, which reduces memory accesses that would have been needed to obtain the additional operand information.

Additionally, or alternatively, in one example, a base-displacement pair provides a resulting value, the resulting value being an address indicating a location of the operand. Use of a base-displacement pair facilitates providing an operand address to be used in execution of the instruction. Multiple addresses used to locate operands are specified in one register, reducing the number of registers to be used and facilitating processing. Performance is improved by having the multiple addresses readily available.

Additionally, or alternatively, in one example, a base-displacement pair of the multiple displacement pairs provides a resulting value. The resulting value being an operand of the multiple operands. Use of a base-displacement pair facilitates providing an operand or an operand address to be used in execution of the instruction. Multiple operands are specified in one register, reducing the number of registers to be used and facilitating processing.

Additionally, or alternatively, in one example, the multiple designations of the multiple operand locations include multiple indications of multiple registers that include multiple operands of the instruction. The multiple indications of the multiple registers are included in the register of the instruction. Use of a single register to provide of multiple register indications improves instruction processing by enabling more operands than the instruction text can support to be used by the instruction. This enables one register to specify multiple registers, which overcomes a constraint of the instruction format when it does not have sufficient fields for the operands to be used and/or is unable to use a parameter block or similar structure for the operand information.

Additionally, or alternatively, in one example, the multiple designations of the multiple operand locations include at least one indication of at least one register that includes at least one operand of the instruction and at least one base-displacement pair to be used to determine at least one other operand of the instruction. Use of a single register to provide multiple designations of multiple operand locations of different types improves instruction processing by enabling more operands than the instruction text can support to be used by the instruction. Further, it provides flexibility for the instruction and instruction processing.

Additionally, or alternatively, in one example, the register is specified in instruction text of the instruction. This facilitates instruction processing, improving processing and reducing latency by not requiring a memory access to obtain an operand of the instruction.

Additionally, or alternatively, in one example, the register is an implied register of the instruction. This facilitates instruction processing, improving processing and reducing latency by not requiring a memory access to obtain an operand of the instruction. Using an implied register further facilitates processing and saves on resources by not having to explicitly specify the register in instruction text.

Additionally, or alternatively, in one example, the plurality of operands includes one or more other operands of the instruction. The one or more other operands of the instruction are obtained from one or more other operand locations specified by a configuration of the instruction.

Additionally, or alternatively, in one example, the instruction is configured with a constraint limiting a number of the operand locations to be specified by instruction text of the instruction, and using the register to provide the multiple designations of the multiple operand locations increases the number of operand locations supported by the instruction. Use of a single register to provide multiple designations of multiple operand locations improves instruction processing by enabling more operands than the instruction text can support to be used by the instruction. Further, instructions are provided with additional functionality by enabling use of additional operands and/or instructions may be configured that previously could not.

In accordance with one or more aspects, each of the embodiments is separable and optional from one another. Further, embodiments may be combined with one another.

In one or more aspects, a computer system is provided. The computer system includes at least one computing device, a set of one or more computer-readable storage media, and program instructions, collectively stored in the set of one or more computer-readable storage media, for causing the at least one computing device to perform computer operations. The computer operations include executing an instruction within a computing environment. Executing the instruction includes obtaining a plurality of operands of the instruction. Obtaining the plurality of operands includes retrieving from a register of the instruction multiple designations of multiple operand locations. The multiple operand locations are used to provide multiple operands of the plurality of operands of the instruction. Multiple operands of the instruction are determined from the multiple operand locations. One or more operations of the instruction are performed using one or more operands of the plurality of operands of the instruction to obtain a result of the instruction. Use of a single register to provide multiple designations of multiple operand locations to obtain multiple operands improves instruction processing by enabling more operands than the instruction text can support to be used by the instruction. Processing cycles are saved and performance is improved by enabling use of more operands by one instruction, thus, providing more functionality with one instruction. Use of multiple designations provides other operands when a parameter block or similar structure is unavailable or, if available, may replace use of a parameter block for operands, which reduces memory accesses that would have been needed to obtain the additional operand information.

Additionally, or alternatively, in one example, the multiple designations of the multiple operand locations include multiple information sets. An information set of the multiple information sets includes a set of values that are combined and used to provide an operand of the multiple operands. Use of a single register to provide multiple information sets improves instruction processing by enabling more operands than the instruction text can support to be used by the instruction. Processing cycles are saved and performance is improved by enabling use of more operands by one instruction, thus, providing more functionality with one instruction. Use of multiple designations provides other operands when a parameter block or similar structure is unavailable or, if available, may replace use of a parameter block for operands, which reduces memory accesses that would have been needed to obtain the additional operand information.

Additionally, or alternatively, in one example, the multiple designations of the multiple operand locations include multiple base-displacement pairs. The multiple base-displacement pairs are used to determine multiple operands of the instruction, and the multiple base-displacement pairs are included in the register of the instruction. Use of a single register to provide multiple base-displacement pairs improves instruction processing by enabling more operands than the instruction text can support to be used by the instruction. Processing cycles are saved and performance is improved by enabling use of more operands by one instruction, thus, providing more functionality with one instruction. Use of multiple designations provides other operands when a parameter block or similar structure is unavailable or, if available, may replace use of a parameter block for operands, which reduces memory accesses that would have been needed to obtain the additional operand information.

Additionally, or alternatively, in one example, the multiple designations of the multiple operand locations include multiple indications of multiple registers that include multiple operands of the instruction. The multiple indications of the multiple registers are included in the register of the instruction. Use of a single register to provide multiple register indications improves instruction processing by enabling more operands than the instruction text can support to be used by the instruction. This enables one register to specify multiple registers, which overcomes a constraint of the instruction format when it does not have sufficient fields for the operands to be used and/or is unable to use a parameter block or similar structure for the operand information.

Additionally, or alternatively, in one example, the multiple designations of the multiple operand locations include at least one indication of at least one register that includes at least one operand of the instruction and at least one base-displacement pair to be used to determine at least one other operand of the instruction. Use of a single register to provide multiple designations of multiple operand locations of different types improves instruction processing by enabling more operands than the instruction text can support to be used by the instruction. Further, it provides flexibility for the instruction and instruction processing.

In accordance with one or more aspects, each of the embodiments is separable and optional from one another. Further, embodiments may be combined with one another.

In one or more aspects, a computer-implemented method is provided. The computer-implemented method includes executing an instruction within a computing environment. Executing the instruction includes obtaining a plurality of operands of the instruction. Obtaining the plurality of operands includes retrieving from a register of the instruction multiple designations of multiple operand locations. The multiple operand locations are used to provide multiple operands of the plurality of operands of the instruction. Multiple operands of the instruction are determined from the multiple operand locations. One or more operations of the instruction are performed using one or more operands of the plurality of operands of the instruction to obtain a result of the instruction. Use of a single register to provide multiple designations of multiple operand locations to obtain multiple operands improves instruction processing by enabling more operands than the instruction text can support to be used by the instruction. Processing cycles are saved and performance is improved by enabling use of more operands by one instruction, thus, providing more functionality with one instruction. Use of multiple designations provides other operands when a parameter block or similar structure is unavailable or, if available, may replace use of a parameter block for operands, which reduces memory accesses that would have been needed to obtain the additional operand information.

Additionally, or alternatively, in one example, the multiple designations of the multiple operand locations include multiple information sets. An information set of the multiple information sets includes a set of values that are combined and used to provide an operand of the multiple operands. Use of a single register to provide multiple information sets improves instruction processing by enabling more operands than the instruction text can support to be used by the instruction. Processing cycles are saved and performance is improved by enabling use of more operands by one instruction, thus, providing more functionality with one instruction. Use of multiple designations provides other operands when a parameter block or similar structure is unavailable or, if available, may replace use of a parameter block for operands, which reduces memory accesses that would have been needed to obtain the additional operand information.

Additionally, or alternatively, in one example, the multiple designations of the multiple operand locations include multiple base-displacement pairs. The multiple base-displacement pairs are used to determine multiple operands of the instruction, and the multiple base-displacement pairs are included in the register of the instruction. Use of a single register to provide multiple base-displacement pairs improves instruction processing by enabling more operands than the instruction text can support to be used by the instruction. Processing cycles are saved and performance is improved by enabling use of more operands by one instruction, thus, providing more functionality with one instruction. Use of multiple designations provides other operands when a parameter block or similar structure is unavailable or, if available, may replace use of a parameter block for operands, which reduces memory accesses that would have been needed to obtain the additional operand information.

Additionally, or alternatively, in one example, the multiple designations of the multiple operand locations include multiple indications of multiple registers that include multiple operands of the instruction. The multiple indications of the multiple registers are included in the register of the instruction. Use of a single register to provide multiple register indications improves instruction processing by enabling more operands than the instruction text can support to be used by the instruction. This enables one register to specify multiple registers, which overcomes a constraint of the instruction format when it does not have sufficient fields for the operands to be used and/or is unable to use a parameter block or similar structure for the operand information.

Additionally, or alternatively, in one example, the multiple designations of the multiple operand locations include at least one indication of at least one register that includes at least one operand of the instruction and at least one base-displacement pair to be used to determine at least one other operand of the instruction. Use of a single register to provide multiple designations of multiple operand locations of different types improves instruction processing by enabling more operands than the instruction text can support to be used by the instruction. Further, it provides flexibility for the instruction and instruction processing.

In accordance with one or more aspects, each of the embodiments is separable and optional from one another. Further, embodiments may be combined with one another.

In one or more aspects, a computer program product is provided. The computer program product includes a set of one or more computer-readable storage media, and program instructions, collectively stored in the set of one or more computer-readable storage media, for causing at least one computing device to perform computer operations including executing an instruction within a computing environment. Executing the instruction includes retrieving from a register of the instruction at least one base-displacement pair of multiple base-displacement pairs located within the register. The at least one base-displacement pair is to be used to provide at least one operand of the instruction. The at least one operand of the instruction is determined from the at least one base-displacement pair. One or more operations of the instruction are performed using, at least, the at least one operand of the instruction to obtain a result of the instruction. Use of a single register to provide multiple base-displacement pairs improves instruction processing by enabling more operands than the instruction text can support to be used by the instruction. Processing cycles are saved and performance is improved by enabling use of more operands by one instruction, thus, providing more functionality with one instruction. Use of multiple designations provides other operands when a parameter block or similar structure is unavailable or, if available, may replace use of a parameter block for operands, which reduces memory accesses that would have been needed to obtain the additional operand information.

In accordance with one or more aspects, each of the embodiments is separable and optional from one another. Further, embodiments may be combined with one another.

In one or more aspects, a computer program product is provided. The computer program product includes a set of one or more computer-readable storage media, and program instructions, collectively stored in the set of one or more computer-readable storage media, for causing at least one computing device to perform computer operations including executing an instruction within a computing environment. Executing the instruction includes retrieving from a register of the instruction at least one operand location designation of a plurality of operand location designations located within the register. The at least one operand location designation is to be used to provide at least one operand of the instruction. The at least one operand of the instruction is determined from the at least one operand location designation. One or more operations of the instruction are performed using, at least, the at least one operand of the instruction to obtain a result of the instruction. Use of a single register to provide multiple designations of multiple operand locations to obtain at least one operand improves instruction processing. Multiple designations enable more operands than the instruction text can support. Processing cycles are saved and performance is improved by enabling use of more operands by one instruction, thus, providing more functionality with one instruction. Use of multiple designations provides other operands when a parameter block or similar structure is unavailable or, if available, may replace use of a parameter block for operands, which reduces memory accesses that would have been needed to obtain the additional operand information.

Additionally, or alternatively, in one example, the at least one operand location designation is selected from a set of operand location designations including an indication of another register and a base-displacement pair. Use of a single register to provide multiple designations of multiple operand locations of different types improves instruction processing by enabling more operands than the instruction text can support to be used by the instruction. Further, it provides flexibility for the instruction and instruction processing.

In accordance with one or more aspects, each of the embodiments is separable and optional from one another. Further, embodiments may be combined with one another.

Computer program products, computer systems and computer-implemented methods relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that, e.g., performs instruction execution processing using expanded register contents and/or one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

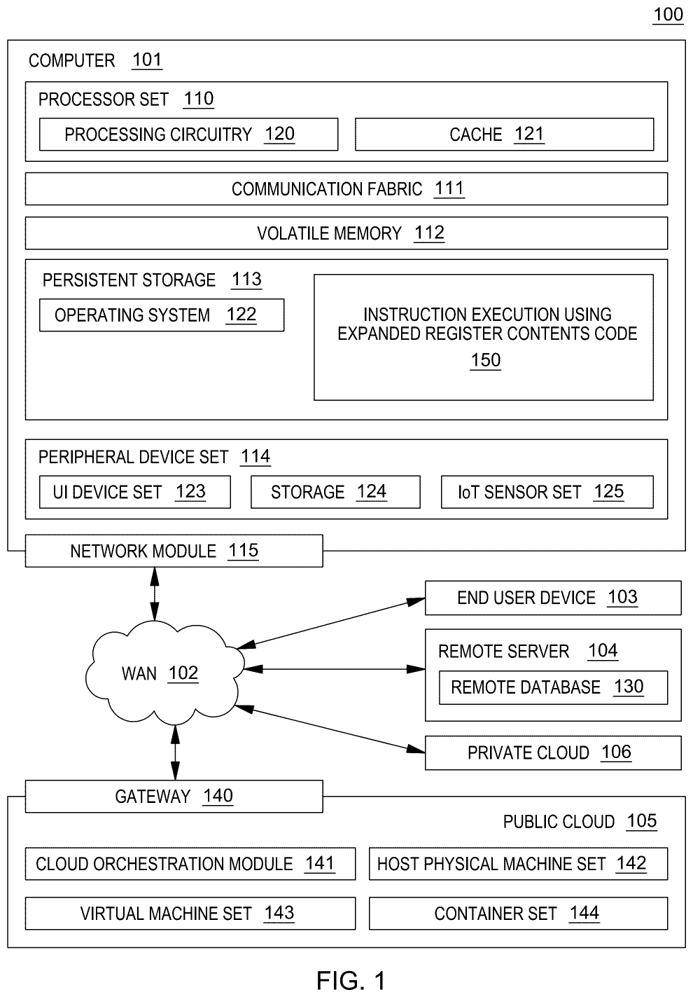

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as instruction execution using expanded register contents code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

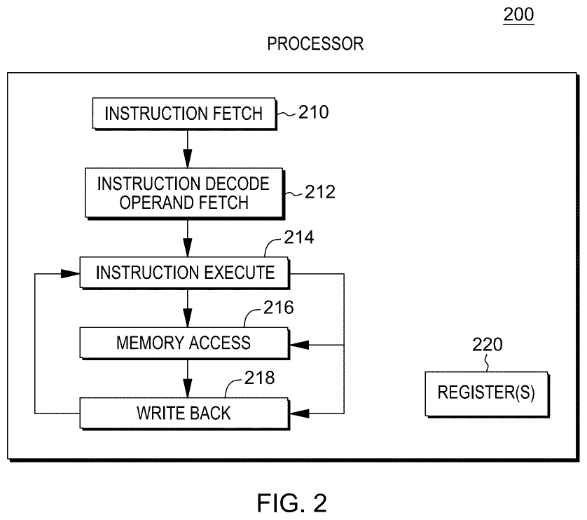

In one example, a processor (e.g., of processor set 110) includes a plurality of functional components (or a subset thereof) used to execute instructions. As depicted in FIG. 2, in one example, a processor 200 includes, for instance, an instruction fetch component 210 to fetch instructions to be executed; an instruction decode/operand fetch component 212 to decode the fetched instructions and to obtain operands of the decoded instructions; one or more instruction execute components 214 to execute the decoded instructions; a memory access component 216 to access memory for instruction execution, if necessary; and a write back component 218 to provide the results of the executed instructions. One or more of the components may access and/or use one or more registers 220 in instruction processing. Further, one or more of the components may access and/or use instruction execution using expanded register contents code 150. Additional, fewer and/or other components may be used in one or more aspects of the present disclosure.

An instruction that may be executed and use expanded register contents, in accordance with one or more aspects of the present disclosure, is part of an instruction set architecture. One example of an instruction set architecture to incorporate and/or use instructions that access and/or employ expanded register contents and/or incorporate and/or use instruction execution processing using expanded register contents is the z/Architecture® instruction set architecture offered by International Business Machines Corporation, Armonk, New York. One embodiment of the z/Architecture instruction set architecture is described in a publication entitled, “z/Architecture Principles of Operation,” IBM Publication No. SA22-7832-13, Fourteenth Edition, May 2022, which is hereby incorporated herein by reference in its entirety. The z/Architecture instruction set architecture, however, is only one example architecture; other architectures and/or other types of computing environments of International Business Machines Corporation and/or of other entities/companies may include and/or use one or more aspects of the present disclosure. z/Architecture and IBM are trademarks or registered trademarks of International Business Machines Corporation in at least one jurisdiction.

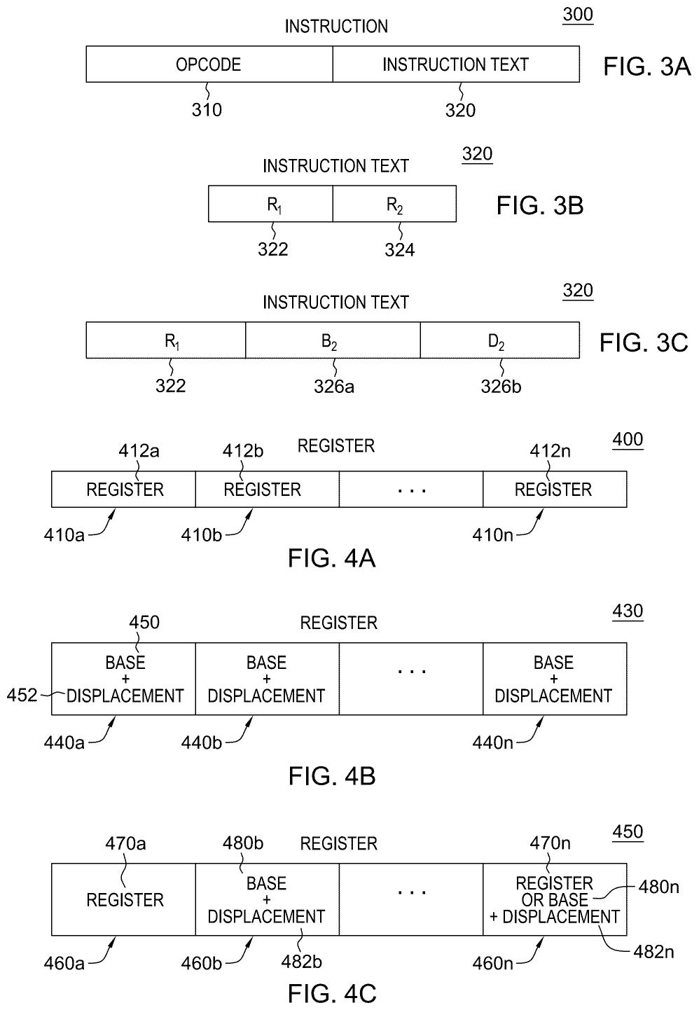

An instruction of an instruction set architecture has a defined format and that format provides the size of the instruction (e.g., 32 bits, 48 bits, etc.) and the fields of the instruction. The fields may include, for instance, indications of registers (e.g., a register number or other identifying information) that provide operands or information used to determine (e.g., generate, locate, define, etc.) the operands; information sets (e.g., base-displacement pairs) that provide operands or information used to determine the operands; immediate fields that include operands or information used to determine the operands; etc. A field of an instruction may have additional, fewer and/or other types of information. Further details relating to instructions and the use of expanded contents registers are described below with reference to FIGS. 3A-4C.

In one example, referring to FIG. 3A, an instruction 300 includes instruction text having at least one operation code (opcode) field 310 and other instruction text 320. Instruction text 320 is used to provide, for instance, one or more operands of the instruction. Instruction text 320 can take on many forms and have many variations, depending on the size of the instruction format, one or more operations to be performed by the instruction, the instruction format, etc. To provide an understanding of one or more aspects of the disclosure, two examples of instruction text are described with reference to FIGS. 3B and 3C; however, there are many other examples that may be provided, including more complex examples. The examples herein are used for clarity purposes only.

In one example, referring to FIG. 3B, instruction text 320 may include a plurality of registers fields (e.g., R₁ 322, R₂ 324), each specifying a register that includes an operand or information to determine an operand. The subscripts indicate which operand the register is associated. For instance, R₁ is for the first operand, R₂ is for the second operand, etc. Further, the subscripted number is not a register number. As an example, R₁ is not necessarily register 1 but can be any available and supported register, as examples.

As another example, referring to FIG. 3C, instruction text 320 may include a plurality of register fields (e.g., R₁ 322, B₂ 326a) and a displacement field D₂ 326b. In the example of FIG. 3C, register field R₁ 322 specifies a register to provide a first operand or information to determine the first operand, and base register field B₂ 326a and displacement field D₂ 326b provide a base-displacement pair that together are used to provide a second operand or information to determine the second operand. In the case of the base-displacement pair, the value in the base register (B₂) specified by register field 326a is concatenated to the value in the displacement field (D₂) 326b to provide a resulting value. That resulting value is the second operand of the instruction or information to determine the second operand (e.g., an address in memory that includes the second operand). Although in this example, there is one D field (e.g., D₂), in other examples, there may be multiple D fields, such as a DH (high part, e.g., 8 bits) and DL (low part, e.g., 12 bits). In such cases, the value in the base register field (e.g., B₂; 4 bits) is concatenated with the values of DH, DL (e.g., DH₂, DL₂) to provide a resulting value. Other examples are possible.

To further explain, in processing within a typical processor (e.g., central processing unit (CPU)), information for a particular instruction is conveyed to the processor in the instruction text and/or by use of specific predefined registers. For instance, an architecture may define specific registers, such as general register 0 (GR0) and/or general register 1 (GR1) as implied registers of the instruction. They are implied since they may be used by the instruction but not specified in the instruction text.

The instruction text includes one or more fields that are, for instance, register fields-fields that specify registers that store operands or information to determine operands; displacement fields-fields that include data to be used with data from other fields (e.g., data from a register or other location) to provide an operand or information to determine an operand; immediate fields-fields that include data to be used as an operand or information to determine an operand; and/or other fields. The fields of the instruction provide the operands of the instruction and the number of operands provided is constrained by the fields of the instruction and/or predefined registers available to the instruction.

In one example, to obtain additional information (e.g., additional operands) for an instruction, a parameter block may be used. The parameter block is located using, for instance, the instruction text or a register predefined for the instruction (e.g., GR0, GR1). For instance, a register specified in the instruction text, other instruction text information or a predefined register points to a memory location of where the parameter block is stored.

The number of operands that may be used for an instruction is constrained. For instance, the operands available to an instruction are those that can be determined by the instruction text and/or parameter block, if a parameter block is available. These constraints may be due to the computing environment in which the instruction is executed, due to architectural constraints of the instruction and/or due to architectural constraints of the instruction set architecture, as examples. Thus, in accordance with one or more aspects of the present disclosure, a capability is provided to expand the contents of a register used by an instruction to provide additional operands. The expansion may be of a register specified by the instruction (e.g., in the instruction text) or an implied register of the instruction. Further, contents of each register of a plurality of registers may be expanded, as described herein.

In one or more aspects, contents of a register used by an instruction are expanded such that the register provides designations of multiple operand locations (also referred to as operand location designations), and thus, multiple operands. As examples, a register of the instruction includes one or more indications of other registers that include one or more operands and/or information to determine one or more operands; a register of the instruction includes one or more information sets (e.g., base-displacement pairs) that include one or more operands and/or information to determine one or more operands; and/or a register of the instruction includes one or more fields that include one or more operands and/or information to determine one or more operands; etc. Other examples are possible.

Examples of expanded register contents are further described with reference to FIGS. 4A-4C. In one example, referring to FIG. 4A, a register 400 is a register used by an instruction (e.g., specified in instruction text, such as R₁ in FIGS. 3B, 3C; R₂ in FIG. 3B; another register specified in instruction text; an implied register (e.g., GR0, GR1); etc.) and includes a plurality of designations of operand locations 410a-n. For instance, instead of register 400 indicating one operand location to determine one operand (e.g., instead of having one operand or information to determine one operand), register 400, in accordance with one or more aspects, includes a plurality of designations of operand locations 410a-n (also referred to individually as operand location designation 410 or collectively as operand location designations 410). In this example, each operand location 410 includes an indication of a register 412a-412n (also referred to individually as register indication 412 or collectively as register indications 412), and each register specified by a register indication 412 includes operand information for the instruction. The operand information is, for instance, an operand of the instruction, part of an operand, and/or information used to determine an operand, as examples.

In another example, referring to FIG. 4B, a register 430 is a register used by an instruction (e.g., specified in instruction text, such as R₁ in FIGS. 3B, 3C; R₂ in FIG. 3C; another register specified in instruction text; an implied register (e.g., GR0, GR1); etc.) and includes a plurality of designations of operand locations 440a-n (also referred to individually as operand location designation 440 or collectively as operand location designations 440). In this example, each operand location designation 440 includes a base 450 (e.g., a base register (e.g., B₂ in FIG. 3C, other base register, other register), other base) and a displacement 452. A value provided by the base is concatenated to another value provided by the displacement to provide a resulting value. This resulting value is operand information of the instruction (e.g., an operand of the instruction, part of an operand, and/or information used to determine an operand, as examples).

In yet another example, referring to FIG. 4C, a register 450 is a register used by an instruction (e.g., specified in instruction text, such as R₁ in FIGS. 3B, 3C; R₂ in FIG. 3C; another register specified in instruction text; an implied register (e.g., GR0, GR1); etc.) and includes a plurality of designations of operand locations 460a-n (also referred to individually as operand location designation 460 or collectively as operand location designations 460). In this example, at least one operand location designation 460 includes at least one indication of at least one register, and each at least one register includes operand information for the instruction (e.g., an operand of the instruction, part of an operand, and/or information used to determine an operand, as examples). Further, at least one operand location designation 460 includes at least one base-displacement pair (or other information set), and each base-displacement pair provides a resulting value (e.g., operand information of the instruction (e.g., an operand of the instruction, part of an operand, and/or information used to determine an operand, as examples)).

For instance, in one particular example, operand location 460a includes an indication of a register 470a (e.g., a register number, other identifying information), operand location 460b includes a base (480b) plus a displacement (482b) (e.g., a base-displacement pair, or other information set), and one or more other operand location designations (e.g., operand location designation 460n) includes an indication of a register 470n, a base (480n) plus displacement (482n), and/or a field that includes, e.g., operand information of the instruction (e.g., an operand of the instruction, part of an operand, and/or information used to determine an operand, as examples)). Other examples are possible and the particular ordering within the register is configurable. For instance, register indication 470a may be in a different location than operand location designation 460a; similarly, base (480b) plus displacement (482b) (or another information set) may be in a different location than operand location designation 460b. The examples described herein are just examples and not meant to be limiting in any way.

Further, a register may include other designations of operand locations. Registers, information sets (e.g., base-displacement pairs) and fields are only examples. Other examples are possible.

In one or more aspects, one or more expanded contents registers are used in execution of the instruction for which they are defined. Many instructions may use one or more expanded contents registers. These instructions may be used in processing within one or more processors of a computing environment, in communications within a processor or between processors of a computing environment, to control operations within one or more processors or between processors of a computing environment, to perform computations including complex operations, to provide security within one or more processors of a computing environment, etc. Many examples of uses of instructions that use one or more expanded contents of registers are possible.

Further, these instructions are used in a wide variety of industries, including, but not limited to, any industry that uses computing resources, computing industries, manufacturing industries, medical industries, automotive industries, etc. Many examples are possible.

In one or more aspects, instruction execution processing using expanded register contents uses instruction execution using expanded register contents code (e.g., instruction execution using expanded register contents code 150). The code is, e.g., computer-readable program code (e.g., instructions) in computer-readable storage media, e.g., storage (persistent storage 113, cache 121, storage 124, other storage, as examples). The computer-readable storage media may be part of one or more computer program products and the computer-readable program code may be executed by and/or using one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute the code and/or portions thereof. Many examples are possible.

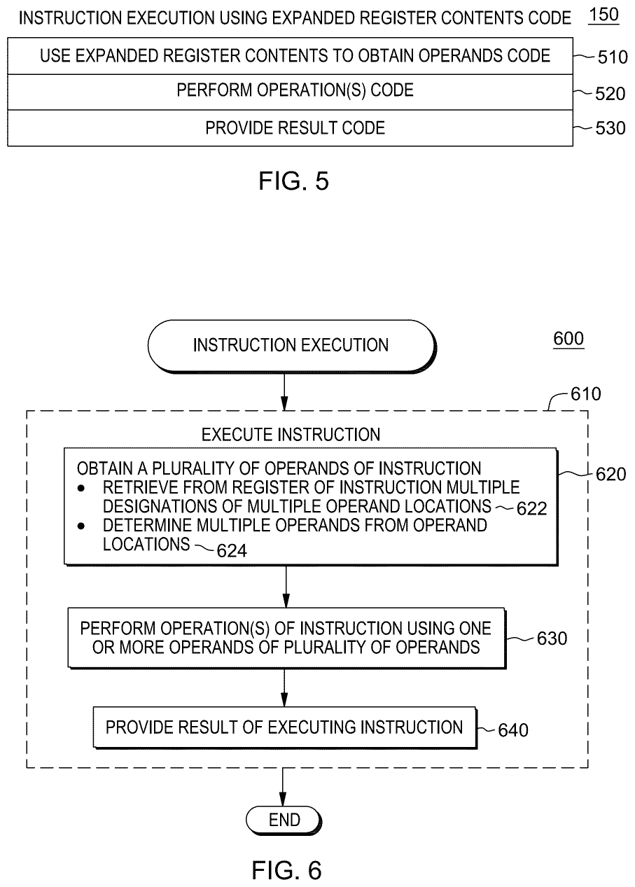

In one example, referring to FIG. 5, instruction execution using expanded register contents code 150 includes, for instance, a use expanded register contents to obtain operands code 510 to be used to obtain one or more operands from at least one expanded contents register; a perform operation(s) code 520 to be used to perform one or more operations of an instruction using the one or more operands determined from the at least one expanded contents register; and provide result code 530 to provide a result of executing the instruction. Additional, less and/or other code may be used.

Although instruction execution using expanded register contents code 150 is depicted in persistent storage 113, one or more code portions may be in other locations, other than persistent storage 113. Many examples are possible.

In one example, instruction execution using expanded register contents code 150 may be used in instruction execution processing. One example of an instruction execution process is described with reference to FIG. 6. In one example, an instruction execution process 600 is executed by one or more computing devices (e.g., one or more computers, such as computer(s) 101 and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute the processing and/or aspects thereof. Many examples are possible.

In one example, an instruction execution process 600 (also referred to as process 600) executes 610 an instruction (e.g., using instruction execution using expanded register contents code 150), and as part of executing the instruction obtains 620 a plurality of operands of the instruction being executed (e.g., using use expanded register contents to obtain operands code 510). Obtaining the plurality of operands includes, for instance, retrieving operand information using the instruction text and/or one or more implied registers of the instruction to be used to determine the operands. In one or more aspects, obtaining 620 the plurality of operands includes retrieving 622 from a register of the instruction multiple designations of multiple operand locations (e.g., indications of other registers, base-displacements pairs (or other information sets), fields, etc.). Process 600 uses the multiple operand locations to determine 624 at least multiple operands of the instruction. The multiple operands may be a subset of the plurality of operands, in which one or more operands are provided by other fields of the instruction text or other registers, or the multiple operands may be the plurality of operands. Other examples are possible.

Further, in other examples, more than one register with expanded register contents may be used. That is, each of one or more registers of the instruction designate multiple operand locations. Further, although a register with expanded register contents may include multiple designations of operand locations, an instruction may use one, or more, of those designations. Many examples are possible.

Based on obtaining the plurality of operands, process 600 performs 630 (e.g., using perform operation(s) code 520) one or more operations (e.g., operations, functions, tasks, actions, etc.) defined by the instruction using one or more operands of the plurality of operands of the instruction.

Based on performing the one or more operations, process 600 provides 640 a result of executing the instruction. The result may be a value, a condition code indicating success or other information relating to execution of the execution, an indicator, a solution, etc. Many examples are possible.

Described above is a capability for using expanded register contents to obtain additional operands for instructions. In one or more aspects, registers with expanded register contents are used to identify additional operands outside of the instruction text and without using a parameter block. In one or more aspects, expanded register contents are used to obtain additional operands for instructions that have formats that are architecturally and/or environmentally constrained and a parameter block is inaccessible (e.g., not used, not able to be used, etc.).

In one or more aspects, a mechanism is provided to specify operands when there is not enough room in instruction text and a program executing the instruction has insufficient access to storage locations for a parameter block. A program might be in an environment where it is to convey more data for an operation that can be identified by, or contained in, the instruction text without a parameter block or it might be in an environment where it is not possible to obtain an area for a parameter block. In one or more aspects, an approach is defined in which operand registers can be identified via instruction text and/or specific registers and the data in those registers can identify an operand address using an approach that need not use an entire specific register to locate an operand.

In one or more aspects, specified registers identify other registers with information. Information is provided in such other registers that may typically be within the instruction text to identify, e.g., the address (location) of data. This address can be provided in a form other than the whole address. For example, a format referred to as base-displacement may be used in which a register contains the base address, and an identified displacement is added to the base address to form the effective address to be used. Depending on the number of bits used for the base and displacement, multiple specifications might fit within a single register. The previously existing approach would have an address within a register, and thus, there would be room for only one per register. The benefit of multiple specifications being possible within a single register is that it can reduce the overall number of registers (there being a limited number available) to identify the operands. That, in turn, makes it more likely that there will be enough available registers to accomplish the function, without having to save and later restore as many registers that might already be in use.

For example, consider a processor (e.g., CPU) architecture with 16 general registers, each of which can be represented by a unique sequence of 4 bits and an offset limited to 4095, so that the offset can be represented in a sequence of 12 bits. Within a 64-bit general register, there is room to identify, e.g., four base-displacement pairs that fit in the preceding definition (e.g., the first in bits 0-15, the second in bits 16-31, etc.). Other examples are possible.

As indicated, many instructions may use expanded register contents, in accordance with one or more aspects of the present disclosure. One particular example of an instruction to use expanded register contents is a compare and swap with triple store instruction, in which there are nine (9) operands.

In this example, for the compare and swap operation of the instruction, there are three (3) operands including: an old value, a new value, and a location of an area to store into. For each of the three stores, two (2) operands are used: the value to store, and the location of an area to store into. Thus, there is a total of six (6) operands for the three stores.

In one specific implementation of the instruction, the instruction utilizes instruction text, an implied register (general register 0 (GR0)), and the information in GR0 and the instruction text to identify the operands and operand values used by the instruction. In one example, the instruction text includes an opcode, R₁, R₃, B₂, D₂ (or in a further example, DH₂, DL₂.) Thus, the instruction text has two operand registers (R₁, R₃) and one operand address (D₂ (B₂), where D₂ is a displacement value (e.g., a set of bits) and B₂ is a base register that includes a value (e.g., another set of bits), and the operand address is the value in the base register specified by B₂ concatenated with the value of D₂).

In one example, GR0 identifies four (4) operand registers (R₄, R₅, R₇, R₉), the 64-bit R₃ register contains three (3) 16-bit base-displacement pairs (each locating an operand address-operand). There is room for four (4) base-displacement pairs within that register, but only three (3) is used for this instruction, in one example. Thus, in accordance with one or more aspects of the present disclosure, the nine (9) operands to be used by the instruction are available to the instruction. Again, the nine (9) operands include:
For the compare and swap: Old value (this is general register R₁ from the instruction text); New value (this is general register R₄ as identified in general register 0); and Location of area to store into (this is base-displacement D₂ (B₂) from the instruction text).
For each of the three stores: The values to store (these are general registers R₅, R₇, R₉, as identified in general register 0 (GR0)); Location of area to store into (these are base-displacements D₆(B₆), D₈(B₈), and D₁₀(B₁₀)) from general register R₃, where general register R₃ is from the instruction text.

Therefore, in accordance with one or more aspects, a general register identified by the instruction text (or “known”, as in general register 0) can indicate other general registers that could contain data or address specifications that are to be looked at. The address specifications, rather than being a full address, use the instruction text of base-displacement and, using the form of, e.g., 12-bit displacement and 4-bit base, there is room for up to four (4) such specifications within a 64-bit general register (the example shown uses three (3), but an instruction may use all four (4)). Many variations to the example provided herein are possible and many examples are possible. The compare and swap instruction is only one example and not meant to be limiting in any way. Other instructions may use extended register contents. In one or more examples, instructions that have insufficient access to operands without using the extended register contents may be configured to use extended register contents. Further, even instructions that can sufficiently provide operands without use of one or more extended register contents may be configured or reconfigured to use extended register contents. Many examples are possible.

Although various examples are described above, other variations and embodiments are possible. Other instructions may use one or more aspects of the present disclosure.

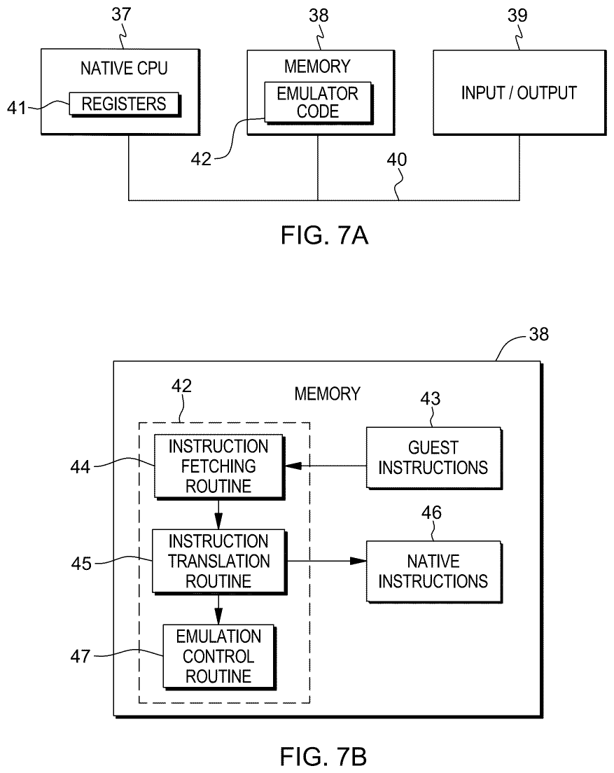

Further, although one or more examples of a computing environment to incorporate and use one or more aspects of the present disclosure are described herein, FIGS. 7A-7B depict another embodiment of a computing environment to incorporate and use one or more aspects of the present disclosure.

Referring, initially, to FIG. 7A, in this example, a computing environment 36 includes, for instance, a native central processing unit (CPU) 37 based on one architecture having one instruction set architecture, a memory 38, and one or more input/output devices and/or interfaces 39 coupled to one another via, for example, one or more buses 40 and/or other connections.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture (different from the one architecture) and to execute software and instructions developed based on the other architecture.

Further details relating to emulator code 42 are described with reference to FIG. 7B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the other instruction set architecture, but instead, are being emulated on native CPU 37, which may be, for example, the one instruction set architecture. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native CPU 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native CPU or by using locations in memory 38. In embodiments, guest instructions 43, native instructions 46 and emulator code 42 may reside in the same memory or may be disbursed among different memory devices.

An example instruction that may be emulated is an instruction that use expanded register contents and/or instruction execution processing that uses expanded register contents may be emulated, in accordance with one or more aspects of the present disclosure.

The computing environments described herein are only examples of computing environments that can be used. One or more aspects of the present disclosure may be used with many types of environments. The computing environments provided herein are only examples. Each computing environment is capable of being configured to include one or more aspects of the present disclosure. For instance, each may be configured to perform instruction execution using expanded register contents and/or perform one or more other aspects of the present disclosure.

One or more aspects of the present disclosure are tied to computer technology and facilitate processing within a computer, improving performance thereof. For instance, the number of registers to be used in instruction processing may be reduced, saving on register resources. Use of storage is reduced by using expanded register contents instead of a parameter block in storage. Processing is improved by providing instructions that were unable to configured. By using these instructions, performance is improved and latency is reduced by reducing the number of memory accesses. Processing within a processor, computer system and/or computing environment is improved.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet a further aspect, a process for integrating computing infrastructure comprising integrating computer-readable code into a computer system may be provided. The computer system comprises a computer-readable medium, in which the computer medium comprises one or more embodiments. The code in combination with the computer system is capable of performing one or more embodiments.

Although various embodiments are described above, these are only examples. For example, other instructions, instruction formats, operands and/or registers may be used. Moreover, additional, less and/or other code may be used. Although code may be provided as an example of performing a particular operation or task, additional and/or other code may be used. Code may be combined and/or separated. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

1. A computer program product comprising:
a set of one or more computer-readable storage media; and
program instructions, collectively stored in the set of one or more computer-readable storage media, for causing at least one computing device to perform computer operations including:
executing an instruction within a computing environment, the executing the instruction including:
obtaining a plurality of operands of the instruction, the obtaining the plurality of operands including:
retrieving from a register of the instruction multiple designations of multiple operand locations, the register being a single register of the instruction, and wherein multiple operand locations provided by the single register are used to provide multiple operands of the plurality of operands of the instruction;
determining from the multiple operand locations the multiple operands of the instruction; and
performing one or more operations of the instruction using one or more operands of the plurality of operands of the instruction to obtain a result of the instruction.

2. The computer program product of claim 1, wherein the multiple designations of the multiple operand locations include multiple information sets, and wherein an information set of the multiple information sets includes a set of values that are combined and used to provide an operand of the multiple operands.

3. The computer program product of claim 2, wherein the multiple information sets include multiple base-displacement pairs, the multiple base-displacement pairs used to determine the multiple operands of the instruction, and wherein the multiple base-displacement pairs are included in the register of the instruction.

4. The computer program product of claim 1, wherein the multiple designations of the multiple operand locations include multiple base-displacement pairs, the multiple base-displacement pairs used to determine the multiple operands of the instruction, and wherein the multiple base-displacement pairs are included in the register of the instruction.

5. The computer program product of claim 4, wherein a base-displacement pair provides a resulting value, the resulting value being an address indicating a location of an operand of the multiple operands.

6. The computer program product of claim 4, wherein a base-displacement pair of the multiple base-displacement pairs provides a resulting value, the resulting value being an operand of the multiple operands.

7. The computer program product of claim 1, wherein the multiple designations of the multiple operand locations include multiple indications of multiple registers that include the multiple operands of the instruction, and wherein the multiple indications of the multiple registers are included in the register of the instruction.

8. The computer program product of claim 1, wherein the multiple designations of the multiple operand locations include at least one indication of at least one register that includes at least one operand of the instruction, and at least one base-displacement pair to be used to determine at least one other operand of the instruction.

9. The computer program product of claim 1, wherein the register is specified in instruction text of the instruction.

10. The computer program product of claim 1, wherein the register is an implied register of the instruction.

11. The computer program product of claim 1, wherein the plurality of operands includes one or more other operands of the instruction, the one or more other operands of the instruction obtained from one or more other operand locations specified by a configuration of the instruction.

12. The computer program product of claim 1, wherein the instruction is configured with a constraint limiting a number of the operand locations to be specified by instruction text of the instruction, and wherein using the register to provide the multiple designations of the multiple operand locations increases the number of operand locations supported by the instruction.

13. A computer system comprising:
at least one computing device;
a set of one or more computer-readable storage media; and
program instructions, collectively stored in the set of one or more computer-readable storage media, for causing the at least one computing device to perform computer operations including:
executing an instruction within a computing environment, the executing the instruction including:
obtaining a plurality of operands of the instruction, the obtaining the plurality of operands including:
retrieving from a register of the instruction multiple designations of multiple operand locations, the register being a single register of the instruction, and wherein the multiple operand locations provided by the single register are used to provide multiple operands of the plurality of operands of the instruction;
determining from the multiple operand locations the multiple operands of the instruction; and
performing one or more operations of the instruction using one or more operands of the plurality of operands of the instruction to obtain a result of the instruction.

14. The computer system of claim 13, wherein the multiple designations of the multiple operand locations include multiple information sets, and wherein an information set of the multiple information sets includes a set of values that are combined and used to provide an operand of the multiple operands.

15. The computer system of claim 13, wherein the multiple designations of the multiple operand locations include multiple base-displacement pairs, the multiple base-displacement pairs used to determine the multiple operands of the instruction, and wherein the multiple base-displacement pairs are included in the register of the instruction.

16. The computer system of claim 13, wherein the multiple designations of the multiple operand locations include multiple indications of multiple registers that include the multiple operands of the instruction, and wherein the multiple indications of the multiple registers are included in the register of the instruction.

17. The computer system of claim 13, wherein the multiple designations of the multiple operand locations include at least one indication of at least one register that includes at least one operand of the instruction, and at least one base-displacement pair to be used to determine at least one other operand of the instruction.

18. A computer-implemented method comprising:
executing an instruction within a computing environment, the executing the instruction including:
obtaining a plurality of operands of the instruction, the obtaining the plurality of operands including:
retrieving from a register of the instruction multiple designations of multiple operand locations, the register being a single register of the instruction, and wherein the multiple operand locations provided by the single register are used to provide multiple operands of the plurality of operands of the instruction;
determining from the multiple operand locations the multiple operands of the instruction; and
performing one or more operations of the instruction using one or more operands of the plurality of operands of the instruction to obtain a result of the instruction.

19. The computer-implemented method of claim 18, wherein the multiple designations of the multiple operand locations include multiple information sets, and wherein an information set of the multiple information sets includes a set of values that are combined and used to provide an operand of the multiple operands.

20. The computer-implemented method of claim 18, wherein the multiple designations of the multiple operand locations include multiple base-displacement pairs, the multiple base-displacement pairs used to determine the multiple operands of the instruction, and wherein the multiple base-displacement pairs are included in the register of the instruction.

21. The computer-implemented method of claim 18, wherein the multiple designations of the multiple operand locations include multiple indications of multiple registers that include the multiple operands of the instruction, and wherein the multiple indications of the multiple registers are included in the register of the instruction.

22. The computer-implemented method of claim 18, wherein the multiple designations of the multiple operand locations include at least one indication of at least one register that includes at least one operand of the instruction, and at least one base-displacement pair to be used to determine at least one other operand of the instruction.

23. A computer program product comprising:
a set of one or more computer-readable storage media; and
program instructions, collectively stored in the set of one or more computer-readable storage media, for causing at least one computing device to perform computer operations including:
executing an instruction within a computing environment, the executing the instruction including:
retrieving from a single register of the instruction at least one base-displacement pair of multiple base-displacement pairs located within the single register, the at least one base-displacement pair to be used to provide at least one operand of the instruction;
determining from the at least one base-displacement pair the at least one operand of the instruction; and
performing one or more operations of the instruction using, at least, the at least one operand of the instruction to obtain a result of the instruction.

24. A computer program product comprising:
a set of one or more computer-readable storage media; and
program instructions, collectively stored in the set of one or more computer-readable storage media, for causing at least one computing device to perform computer operations including:
executing an instruction within a computing environment, the executing the instruction including:
retrieving from a single register of the instruction at least one operand location designation of a plurality of operand location designations located within the single register, the at least one operand location designation to be used to provide at least one operand of the instruction;
determining from the at least one operand location designation the at least one operand of the instruction; and
performing one or more operations of the instruction using, at least, the at least one operand of the instruction to obtain a result of the instruction.

25. The computer program product of claim 24, wherein the at least one operand location designation is selected from a set of operand location designations including an indication of another register and a base-displacement pair.
